(19) United States
(12) Patent Application Publication
(10) Pub. No.: US 2017/0165613 A1
(43) Pub. Date: Jun. 15, 2017

(54) HOLLOW FIBER MEMBRANES FORMED FROM TRANS-1,3,3,3-TETRAFLUOROPROPENE AND VINYLIDENE DIFLUORIDE FLUOROPOLYMERS

(71) Applicant: HONEYWELL INTERNATIONAL INC., Morris Plains, NJ (US)

(72) Inventors: David Nalewajek, West Seneca, NY (US); Andrew Joseph Poss, Kenmore, NY (US)

(21) Appl. No.: 15/370,416

(22) Filed: Dec. 6, 2016

Related U.S. Application Data
(60) Provisional application No. 62/265,288, filed on Dec. 9, 2015.

(51) Int. Cl. B01D 71/32; B01D 69/08; B01D 67/00; C08F 214/22

(52) U.S. Cl. CPC B01D 71/32; C08F 214/22; B01D 69/087; B01D 67/0088; B01D 67/0011; B01D 67/0016

(57) ABSTRACT

Hollow fiber membranes comprising fluoro-copolymers, and processes of making and using the hollow fiber membranes are described. The fluoro-copolymers have a weight average molecular weight between about 100,000 and about 500,000 Daltons. The fluoro-copolymer comprises trans-1,3,3,3-tetrafluoropropene monomers and vinylidene difluoride monomers, and at least 50 wt % of the fluoro-copolymer comprises trans-1,3,3,3-tetrafluoropropene monomers.

This application claims the benefit of U.S. Provisional Ser. No. 62/265,288, filed Dec. 9, 2015, which is incorporated herein in its entirety.

### FIELD OF THE INVENTION

The present invention generally relates to fluoro-copolymers of trans-1,3,3,3-tetrafluoropropene and vinylidene difluoride monomers, and more particularly to hollow fiber membranes comprising such fluoro-copolymers.

### BACKGROUND OF THE INVENTION

Membrane based technologies generally have lower capital costs and higher energy efficiency compared with older technologies such as cryogenic distillation, adsorption, and absorption. As a result, membrane based technologies are being developed for a variety of industries.

Membranes can be made as flat sheets or hollow fibers. Asymmetric integrally skinned flat sheet membranes have a thin, dense, nonporous selective skin that performs the separation supported on a highly porous substrate made of the same material. These membranes can be made from a casting dope by a dry-wet phase inversion process. Flat sheet membranes can also be thin film composites made by lamination or dip coating.

Hollow fiber membranes can also be either asymmetric integrally skinned or thin film composites. They generally have an outside diameter about 1 mm or less. The outer wall of the fiber functions as a semipermeable membrane.

Hollow fiber membranes have several advantages over flat sheet membranes. Hollow fiber membranes have a much higher surface area per unit volume, which can result in more efficient separation. Moreover, they are generally self-supporting, whereas flat sheet and thin film membranes require a support structure.

Hollow fibers are generally made using a solution spinning process via a dry-wet phase inversion technique in which a large amount of solvent is introduced into the center (or bore) of the fiber. The complexity of the spinning process makes production of hollow fiber membranes quite challenging. The first step of the process involves forming a membrane casting solution containing the polymer, a solvent, and a non-solvent for the polymer. The membrane casting solution is extruded simultaneously with a bore fluid, which can be any fluid which does not dissolve the polymer, through a spinneret. The membrane casting solution is pumped into the outer layer of the annulus of the spinneret, and the bore fluid is pumped into the center of the annulus to form the bore in the fiber. The hollow fiber may then be passed through an air gap, and immersed in a bath.

The polymers used to make hollow fiber membranes desirably include one or more of the following properties. The polymer should have sufficient mechanical strength so that a hollow fiber can be spun and so that the hollow fiber does not collapse. It should be flexible enough that it can be spun without breaking but not elongate during spinning

The polymer should be soluble in one or more solvents so that the hollow fiber membranes can be produced using the dry-wet phase inversion process, with low boiling point and/or low VOC solvents being desirable.

The polymer should resist biofouling and not be reactive with chemical agents used to clean the membrane, such as bleach and or NaOH. Biofouling is an undesirable accumulation and growth of living matter on wetted surfaces. Fouling can occur either on the surface of the hollow fiber membrane or in the pores, and it results in a decrease in flux. Fouling increases costs because the hollow fiber membrane must be cleaned, and the cleaning process may reduce the membrane life.

The porosity, and pore opening size and distribution of the hollow fiber membrane can be important. The pore opening size distribution is a statistical distribution of the range of pore opening sizes in the membrane wall. The smaller the pore opening size, the smaller the particle that the membrane will separate. The pore opening size and distribution are determined using scanning electron microscopy (SEM). Porosity (also known as void volume) is the portion of the membrane filter volume that is open to fluid flow. The higher the porosity, the more open space there is in the membrane, which typically results in an increased flux through the membrane. Porosity is a function of the material the membrane is made from, and it can be adjusted using pore forming compounds, such as lithium chloride, glycerol, phosphoric acid, and polyvinyl pyrrolidone polymer (PVP), if needed.

Another property related to the porosity of the hollow fiber membrane is the membrane water permeability coefficient, which represents the relationship between the flowrate of pure water and the pressure applied. The membrane water permeability coefficient is defined as the amount of water produced per unit area of membrane per unit area of net driving pressure. It can be determined according to the method described in Characterization of novel forward osmosis hollow fiber membranes, Journal of Membrane Science, 355 (2010) p. 158-167.

The molecular weight cut-off is another property of the membrane which can be important. It is a measure of the size of the particles that can pass through the membrane. The molecular weight cut-off is the lowest weight average molecular weight solute (in Daltons) in which 90% of the solute is retained by the membrane or the weight average molecular weight of a solute where 90% of the molecules would be retained by the membrane. The molecular weight cut-off can be altered using pore forming compounds. The molecular weight cutoff can be measured using the process described in TRANSFER OF DEXTRAN THROUGH ULTRAFILTRATION MEMBRANES: A STUDY OF REJECTION DATA ANALYSED BY GEL PERMEATION CHROMATOGRAPHY, Journal of Membrane Science 45 (1989) 17.

Some specific applications require additional desirable properties. For example, stability in acidic environments is desirable for reverse osmosis separations. Membrane distillation (MD) requires a high hydrophobicity of the membrane materials.

Fluorine-containing monomers, polymers and copolymers, or fluoropolymers, are known. See, for example, U.S. Pat. Nos. 2,970,988, 2,931,840, 2,996,555, 3,085,996, 6,486,281, 6,867,273 (see, Column 3, line 29-50) and 6,703,450 (see, Column 2, line 42, to Column 3, line 5, for monomers), as well as U.S. Pat. Pub. Nos. 2008/0171844, 2008/0153977, 2014/0339167, and 2014/0147480.

Common fluoropolymers lack one or more of the important properties for use in hollow fiber membranes. For example, polytetrafluoroethylene (PTFE) polymers are insoluble in all solvents, including commonly used solvents such as N-methyl pyrrolidone, tetrahydrofuran, dimethylformamide, and dimethylacetamide. As a result, PTFE is typically provided as a dispersion of powder particles in an aqueous carrier, which cannot be drawn into a hollow fiber membrane. Hollow fiber membranes can be produced from PTFE using processes such as cold pressing, extrusion, and expansion. However, these processes are more difficult than the solution spinning process.

Another fluoropolymer, polyvinylidene difluoride (PVDF), is soluble in N-methyl pyrrolidone and dimethylacetamide, and has been used to make hollow fibers. However, the use of these solvents is undesirable due to their toxicity and/or carcinogenicity. In addition, a membrane made of PVDF for applicants was found to have no water permeability measured as described above.

Accordingly, there remains a need for hollow fiber membranes made from fluoropolymers, and for methods of making the hollow fiber membranes.

### SUMMARY OF THE INVENTION

The present invention relates generally to hollow fiber membranes formed from polymers comprising trans-1,3,3,3-tetrafluoropropene (CF3CH═CHF) monomers and vinylidene difluoride (CH₂═CF₂, VDF) monomers, and the processes of making and using the hollow fiber membranes.

One aspect of the invention is a hollow fiber membranes comprising fluoro-copolymers. The fluoro-copolymers have a weight average molecular weight between about 100,000 and about 500,000 Daltons. The fluoro-copolymer comprises trans-1,3,3,3-tetrafluoropropene monomers and vinylidene difluoride monomers, and at least 50 wt % of the fluoro-copolymer comprises trans-1,3,3,3-tetrafluoropropene monomers.

Another aspect of the invention is a process for producing a hollow fiber membrane. The process involves providing a membrane casting solution comprising a solvent and the fluoro-copolymer; spinning the membrane casting solution with a bore fluid through a spinneret to form a hollow fiber membrane; and introducing the hollow fiber membrane into a coagulation bath.

Another aspect of the invention is a separation process using the hollow fiber membrane. The process includes providing a hollow fiber membrane; passing a feed into the hollow fiber membrane, the feed comprising at least two components; and selectively separating the feed into a permeate comprising the first component and a retentate comprising the second component.

### DETAILED DESCRIPTION OF THE INVENTION

Applicants have discovered that hollow fiber membranes can be made using fluoro-copolymers comprising trans-1,3,3,3-tetrafluoropropene and vinylidene difluoride monomers. The trans-1,3,3,3-tetrafluoropropene comprises at least 50 wt % of the monomers of the fluoro-copolymers. The fluoro-copolymers have a weight average molecular weight of about 100,000 Daltons to about 500,000 Daltons. The weight average molecular weight of the fluoro-copolymers is measured by gel permeation chromatography (GPC) with a polystyrene and poly(methyl methacrylate) based calibration, as is known in the art. Specifically, weight average molecular weight is measured by GPC according to the method described in Skoog, Principles of Instrumental Analysis, 6th Ed., Chapter 28, Thompson Brooks/Cole, Belmont Calif., 2006. The weight average molecular weight was measured on a GPC instrument from Agilient Technologies PL-GPC-220, using Polymer Labs gel 10 mm mixed C 300×7.5 mm columns at 50° C. using polystyrene and polymethylmethacrylate standards. The calibration range is over the molecular weight range of 1000 to 2 million Daltons. The sample size is 10 mg of polymer dissolved in 2 ml of tetrahydrofuran.

These fluoro-copolymers possess the flexibility and strength to be utilized for hollow fibers. They are soluble in a wide range of solvents, including low boiling point solvents and low VOC solvents.

### The Fluoro-Copolymers

The fluoro-copolymers comprise trans-1,3,3,3-tetrafluoropropene monomers and vinylidene difluoride monomers. The trans-1,3,3,3-tetrafluoropropene monomers may comprise from about 50 to about 70 wt % of the monomers of the fluoro-copolymers, or from about 55 to about 65 wt % of the monomers of the fluoro-copolymers, or from about 58 to about 62 wt % of the monomers of the fluoro-copolymers, or about 60 wt % of the monomers of the fluoro-copolymers. The vinylidene difluoride monomers may comprise from about 30 to about 50 wt % of the monomers of the fluoro-copolymers, or from about 35 to about 45 wt % of the monomers of the fluoro-copolymers, or from about 38 to about 42 wt % of the monomers of the fluoro-copolymers, or about 40 wt % of the monomers of the fluoro-copolymers. In some embodiments, the fluoro-copolymers comprise trans-1,3,3,3-tetrafluoropropene and vinylidene difluoride monomers in a 60/40 weight ratio. The fluoro-copolymers used in the present invention can consist essentially of the above weight percentages of trans-1,3,3,3-tetrafluoropropene monomers and vinylidene difluoride monomers. The fluoro-copolymers used in the present invention can consist of the above weight percentages of trans-1,3,3,3-tetrafluoropropene monomers and vinylidene difluoride monomers.

The fluoro-copolymer may contain small levels of other components, typically impurities. Thus, the fluoro-copolymer may comprise no more than 1 wt % of any other components or monomers, for example, monomers other than trans-1,3,3,3-tetrafluoropropene and vinylidene difluoride.

Applicants have unexpectedly found that the weight average molecular weight is an important factor in the ability to produce hollow fiber membranes from these fluoro-copolymers. Suitable fluoro-copolymers have a weight average molecular weight of about 100,000 Daltons to about 500,000 Daltons, or about 200,000 Daltons to about 400,000 Daltons. If the weight average molecular weight (MW) of the fluoro-copolymers is greater than about 500,000 Daltons, the fluoro-copolymers fibers do not form properly and are difficult or impossible to draw from the solvent. Because of the lower solubility of fluoro-copolymers with a MW above about 500,000 Daltons, it tends to collect or agglomerate, and it may form a gel and separate from the solution. If the average molecular weight of the fluoro-copolymers is too low, for example, less than about 100,000 Daltons, it is difficult to make a solution with a viscosity that is high enough so that it is possible to form the hollow fibers. Weight average molecular weight is measured by gel phase chromatography (GPC) as described above.

### Fluoro-Copolymer Production

The fluoro-copolymers may be formed using one or a combination of different applications and techniques known in the art. For example, fluoro-copolymers may be formed using one or a combination of several preferred techniques, including, (1) emulsion polymerization; (2) solution or suspension polymerization; (3) supercritical carbon dioxide polymerization; (4) stereoselective polymerization; (5) transition metal catalyzed polymerization; (6) radiation or thermal polymerization; and combinations thereof. A detailed description of such methods is disclosed in U.S. Patent Publication Nos. 2013-0089671 A1 and 2013-009049 A1, which are hereby incorporated herein by reference in their entirety.

### Hollow Fiber Membrane Production

The hollow fiber membranes comprising fluoro-copolymers may be made according to known methods, such as the dry-wet phase inversion technique, which will be described below. This process is generally disclosed in U.S. Pat. Nos. 8,641,807 and 8,366,804, and U.S. Pub. No. 2014/0339167, which are incorporated herein by reference.

### Membrane Casting Solution

The fluoro-copolymers can be dissolved in an organic solvent or mixture of solvents to form a membrane casting solution. The solvents may be, but are not required to be, polar solvents, either protic or aprotic. Exemplary solvents include, but are not limited to, ethyl acetate, acetone, cis- or trans-1-chloro-3,3,3-trifluoropropene (HFO-1233zd), tetrahydrofuran, dimethylformamide, dimethylsulfoxide, dimethylacetamide, 1,1,1,3,3-pentafluorobutane, N-methyl pyrrolidone, ethanol, methanol, 1,3-dioxolane, or mixtures thereof.

The amount of solvent used to form the membrane casting solution may vary depending on the solvent being used, the molecular weight of the fluoro-copolymer, and the ratio of trans-1,3,3,3-tetrafluoropropene monomers to vinylidene difluoride monomers. For the solvents listed above, the fluoro-copolymer concentration typically ranges from about 15 wt % to about 50 wt % of the solution, or about 17 wt % to about 45 wt %, or about 20 wt % to about 45 wt %, or about 20 wt % to about 35 wt %, or about 20 wt % to about 30 wt %.

The membrane casting solution may, optionally, include one or more additives commonly used in hollow fiber membranes and flat sheet membranes. The additives may be provided to improve one or more characteristics of the fluoro-copolymers coating composition. By way of non-limiting example, silica and/or silica- or carbon-based nanoparticles may be provided to change surface energy and refractive index of the composition. Additional additives may be provided to assist with insulation of the coating, anti-corrosion, with hydrophobicity, therapeutic effects, substrate bonding or adhesion, or the like. Some additives may be added to increase the porosity of the fluoropolymers. Suitable additives may include, but are not limited to, high- or low-temperature additives, fillers, pigments, saturants, lubricants, tackifiers, adhesion promoters, film-formers, thickeners, processing aids, electrically conductive materials, electrically insulative materials, stabilizers, impact modifiers, viscosity modifiers, or any other additive that improves one or more of the properties herein or which is otherwise compatible with the fluoropolymers. One of skill in the art will appreciate, however, that the present invention is not limited to such additives generally or with each composition and that these or any composition of the present invention may be modified to include one or more additives otherwise known or may be useful for the purpose provided. Typically, the final coating comprises no more than 25 wt. %, or no more than 20 wt. % or no more than 15 wt. %, or no more than 10 wt. %, or no more than 5 wt. %, or no more than 1 wt. %, or less than 1 wt. % of the additives.

For example, at least one pore forming compound can be included in the membrane casting solution to increase of permeability of the hollow fiber membrane. Pore forming compounds include, for example, lithium chloride, glycerol, phosphoric acid, and polyvinyl pyrrolidone polymer (PVP). The pore forming compounds are typically added an amounts up to about 35 wt % of the membrane casting solution, typically less than about 10 wt %, or in the range of about 0.5 wt % to about 7 wt %, or about 0.5 wt % to about 5 wt %.

The casting solution typically has a viscosity in the range of about 5,000 to about 30,000 cSt at 40° C. in dimethyl acetamide (DMAC) or acetic acid (AcOH) in order to make hollow fiber membranes, or about 5,000 to about 25,000 cSt, or about 5,000 to about 20,000 cSt, or about 5,000 to about 15,000 cSt, or about 5,000 to about 10,000 cSt. The viscosity was measured on a Fugilab Inc. Expert Series Rotational Viscometer. Measurements were made at 40° C. by dissolving 8.75 g of fluoro-copolymer copolymer in 16.25 g of DMAC, which represents a 35 wt % solution of the fluoro-copolymer in the solvent. About 11 ml of this solution was added to the sample holder. After 1 hr of equilibration at 40° C., the viscosity of the solution was measured using a number TR-10 spindle. Similar results would be obtained using AcOH as the solvent.

### Hollow Fiber Spinning

The next step involves spinning the membrane casting solution from the outer, annular orifice of a tube-in-orifice spinneret, such as described in US Pat. No. 5,762,798. A bore fluid is simultaneously delivered to the tube of the spinneret. The bore fluid can be a fluid which does not dissolve the polymer. Water and water/alcohol mixtures are commonly used as the bore fluid, although other liquids can also be used. Additives, such as sodium bicarbonate, sodium hydroxide, and/or citric acid can be added to the bore fluid to assist in removing the solvent from the membrane casting solution after the hollow fiber is formed. These additives can be included in amounts of about 0.5 wt % to about 5 wt % of the bore fluid.

The nascent hollow fiber membrane is passed downward into a coagulation bath. The coagulation bath contains a non-solvent for the polymer, i.e., any solvent in which the polymer will not dissolve (e.g., water). The polymer becomes a solid in the coagulation bath. The solvent from the membrane casting solution enters the coagulation bath. The non-solvent in the coagulation bath can be the same fluid as the bore fluid if desired, although this is not required.

The nascent hollow fiber membrane is introduced into the coagulation bath at a controlled temperature which is in a range of about 0° C. to about 40° C., or about 10° C. to about 40° C., or about 20° C. to about 40° C., or about 30° C. to about 40 ° C. The hollow fibers are then wound on a drum, a roll, or other suitable device.

The water wet hollow fibers may be annealed in a hot water bath at a temperature in a range of about 30° C. to about 100° C. for about 1 minute to about 3 hours to remove any pore forming additives and any remaining solvent from the casting solution.

In some embodiments, the hollow fiber membrane may be dried; however, drying is not required. If too much water is removed, the hollow fiber membrane may collapse.

If a drying step is employed, the hollow fiber membrane may be dried at a temperature in a range of about 23° C. to about 150° C., or about 30° C. to about 150° C., or about 50° C. to about 150° C., or about 50° C. to about 100° C. Drying may be carried out for any length of time necessary, for example, from about 1 minute to about 12 hours, or from about 1 minute to about 10 hours, or from about 1 minute to about 8 hours, or from about 1 minute to about 6 hours, or from about 1 minute to about 5 hours, or from about 1 minute to about 4 hours, or from about 1 minute to about 3 hours, or from about 1 minute to about 2 hours, or from about 1 minute to about 1 hour, or from about 10 minutes to about 1 hour. One of ordinary skill in the art will appreciate that allowing the membrane and/or substrate to dry may be accomplished at a variety of processing conditions and thus, these conditions are merely exemplary.

In some embodiments, the hollow fiber membranes are not dried at all or are not completely dried in order to prevent them from collapsing. In some cases, a solvent exchange step is added after the annealing step and before the optional drying step (or instead of the optional drying step). Substantially all of the water is removed from the membrane by a sequential solvent exchange with a replacement liquid, as taught in U.S. Pat. Nos. 4,080,744 and 4,120,098. Replacement liquids can be organic solvents or aqueous mixtures thereof. Suitable replacement liquids include, but are not limited to, aliphatic alcohols, aldehydes, ketones, carboxylic acids, carboxylic esters, nitriles, ethers acetals, ketals, amines and halocarbons. Examples include glycerol, methanol and hexane.

In some cases, a membrane post-treatment step can be added after the optional drying step in order to change the surface energy of the membrane so that it does not foul as easily. The post-treatment step does not change or damage the membrane, or cause the membrane to lose performance with time. The membrane post-treatment step can involve coating the selective layer surface of the hollow fiber membrane with a thin layer of material such as a polysiloxane, a fluoro-polymer, a thermally curable silicone rubber, or a UV radiation curable silicone rubber.

The fluoro-copolymer typically may comprise a 60/40 weight ratio of trans-1,3,3,3-tetrafluoropropene monomers and vinylidene difluoride monomers with a weight average molecular weight of about 200,000 Daltons to 350,000 Daltons.

The membrane casting solution may contain a fluoro-copolymer concentration of fluoro-copolymer of about 20 wt % to about 30 wt %. The solvent may be ethanol, methanol, or cis- or trans-l-chloro-3,3,3-trifluoropropene, or a mixture thereof. The membrane casting solution may contain about 0.5 wt % to about 5 wt % of a pore forming compound. The pore forming compound may be polyvinyl pyrrolidone. The viscosity of the membrane casting solution is in the range of about 5,000 to about 10,000 cSt at 40° C. in DMAC.

The membrane casting solution may be spun simultaneously with a bore fluid from an annular spinneret using a hollow fiber spinning machine and introduced into a coagulation bath. The bore fluid may be water, and the coagulation bath may contain water. The coagulation bath may be at a temperature in the range of about 30° C. to about 40° C.

### Applications

The fluoro-copolymer hollow fiber membranes may be used in various filtration or separation processes including, for example, reverse osmosis desalination, filtration, membrane distillation, pervaporation, and selective gas separation.

A separation process may include passing a feed comprising two or more components through the fluoro-copolymer hollow fiber membrane to separate the feed selectively and provide a permeate comprising the first component and a retentate comprising the second component. For example, the selective separation process may comprise water desalination, solids filtration, selective gas separation, ultrafiltration, or any other selective separation process.

### Aspects of the Invention

Aspects of the invention are provided below:

Aspect 1: a hollow fiber membrane comprising: a hollow tube comprising a fluoro-copolymer having a weight average molecular weight between about 100,000 and 500,000 Daltons, the fluoro-copolymer comprising trans-1,3,3,3-tetrafluoropropene monomers and vinylidene difluoride monomers, wherein at least 50 wt % of the fluoro-copolymer comprises trans-1,3,3,3-tetrafluoropropene monomers.

Aspect 2: the membrane according to aspect 1, wherein the weight average molecular weight of the fluoro-copolymer is between about 200,000 and 400,000 Daltons.

Aspect 3: the membrane according to any one of aspects 1 to 2, wherein the fluoro-copolymer comprises from at least 50 wt % to about 70 wt % trans-1,3,3,3-tetrafluoropropene monomers.

Aspect 4: the membrane according to any one of apects 1 to 3, wherein the fluoro-copolymer comprises from about 55 to about 65 wt % trans-1,3,3,3-tetrafluoropropene monomers.

Aspect 5: the membrane according to any one of aspects 1 to 4, wherein the fluoro-copolymer comprises from about 58 to about 62 wt % trans-1,3,3,3-tetrafluoropropene monomers.

Aspect 6: the membrane according to any one of aspects 1 to 5, wherein the fluoro-copolymer comprises 60 wt % trans-1,3,3,3-tetrafluoropropene monomers and 40 wt % vinylidene difluoride monomers.

Aspect 7: a process for producing a hollow fiber membrane comprising: providing a membrane casting solution comprising:
a solvent selected from the group consisting of: ethyl acetate; acetone; cis- or trans-1-chloro-3,3,3-trifluoropropene; tetrahydrofuran; dimethylformamide; dimethylsulfoxide; dimethylacetamide; 1,1,1,3,3-pentafluorobutane; N-methyl pyrrolidone; ethanol; methanol; 1,3-dioxolane; or mixtures thereof; and
a fluoro-copolymer having a weight average molecular weight between about 100,000 and 500,000 Daltons, the fluoro-copolymer comprising trans-1,3,3,3-tetrafluoropropene monomers and vinylidene difluoride monomers, wherein at least 50 wt % of the fluoro-copolymer comprises trans-1,3,3,3-tetrafluoropropene monomers;
spinning the membrane casting solution with a bore fluid through a spinneret to form a hollow fiber membrane; and
introducing the hollow fiber membrane into a coagulation bath.

Aspect 8: the process according to aspect 7, further comprising annealing the hollow fiber membrane after introducing hollow fiber membrane into the coagulation bath.

Aspect 9: the process according to aspect 8, wherein the hollow fiber membrane is annealed at a temperature of about 30° C. to about 100° C. for a time of about 10 minutes to about 3 hours.

Aspect 10: the process according to any one of aspects 7 to 9, further comprising introducing the hollow fiber membrane into a solvent exchange bath after introducing hollow fiber membrane into the coagulation bath.

Aspect 11: the process according to aspect 10, wherein the solvent exchange bath comprises at least one of methanol and hexane.

Aspect 12: the process according to any one of aspects 7 to 11, further comprising drying the hollow fiber membrane after introducing hollow fiber membrane into the coagulation bath.

Aspect 13: the process according to aspect 12, wherein the hollow fiber membrane is dried at a temperature of about 23° C. to about 150° C. for a time of about 1 minute to about 12 hours.

Aspect 14: the process according to any one of aspects 7 to 13, wherein the coagulation bath comprises water.

Aspect 15: the process according to any one of aspects 7 to 14 wherein the coagulation bath is at a temperature about 0° C. to about 30° C.

Aspect 16: the process according to any one of aspects 7 to 15 further comprising coating the surface of the hollow fiber membrane with polysiloxane, a fluoro-polymer, a thermally curable silicone rubber, or a UV radiation curable silicone rubber after introducing hollow fiber membrane into the coagulation bath.

Aspect 17: the process according to any one of aspects 7 to 16, wherein the membrane casting solution further comprises a pore forming compound.

Aspect 18: the process according to any one of aspects 7 to 17, wherein the weight average molecular weight of the fluoro-copolymer is between about 200,000 and 400,000 Daltons.

Aspect 19: the process according to any one of aspects 7 to 18, wherein the fluoro-copolymer comprises from about 50 to about 70 wt % trans-1,3,3,3-tetrafluoropropene monomers.

Aspect 20: the process according to any one of claims 7 to 19, wherein the fluoro-copolymer comprises about 60 wt % trans-1,3,3,3-tetrafluoropropene monomers and about 40 wt % vinylidene difluoride monomers.

Aspect 21: a separation process comprising:
providing a hollow fiber membrane according to any one of aspects 1 to 6;
passing a feed into the hollow fiber membrane, the feed comprising at least two components; and
selectively separating the feed into a permeate comprising the first component and a retentate comprising the second component.

Aspect 22: the separation process according to aspect 21, wherein the separation process comprises at least one of reverse osmosis desalination, filtration, membrane distillation, pervaporation, and selective gas separation.

Aspect 23: a hollow fiber membrane comprising: a fluoro-copolymer comprising trans-1,3,3,3-tetrafluoropropene monomers and vinylidene difluoride monomers, wherein at least 50 wt % of the fluoro-copolymer comprises trans-1,3,3,3-tetrafluoropropene monomers, and the fluoro-copolymer has a weight average molecular weight between about 100,000 and about 500,000 Daltons.

Aspect 24: the hollow fiber membrane according to aspect 23, wherein the trans-1,3,3,3-tetrafluoropropene monomers comprise from about 50 to about 70 wt % of the monomers of the fluoro-copolymer.

Aspect 25: the hollow fiber membrane according to aspect 23, wherein the trans-1,3,3,3-tetrafluoropropene monomers comprise from about 55 to about 65 wt % of the monomers of the fluoro-copolymer.

Aspect 26: the hollow fiber membrane according to aspect 23, wherein the trans-1,3,3,3-tetrafluoropropene monomers comprise from about 58 to about 62 wt % of the monomers of the fluoro-copolymer.

Aspect 27: the hollow fiber membrane according to aspect 23, wherein the trans-1,3,3,3-tetrafluoropropene monomers comprise about 60 wt % of the monomers of the fluoro-copolymer.

Aspect 28: the hollow fiber membrane according to any one of aspects 23 to 27, wherein the vinylidene difluoride monomers comprise from about 30 to about 50 wt % of the monomers of the fluoro-copolymer.

Aspect 29: the hollow fiber membrane according to any one of aspects 23 to 27, wherein the vinylidene difluoride monomers comprise from about 35 to about 45 wt % of the monomers of the fluoro-copolymer.

Aspect 30: the hollow fiber membrane according to any one of aspects 23 to 27, wherein the vinylidene difluoride monomers comprise or from about 38 to about 42 wt % of the monomers of the fluoro-copolymer.

Aspect 31: the hollow fiber membrane according to any one of aspects 23 to 27, wherein the vinylidene difluoride monomers comprise about 40 wt % of the monomers of the fluoro-copolymers.

Aspect 32: the hollow fiber membrane according to any one of aspects 23 to 31, wherein the fluoro-copolymer has a weight average molecular weight of about 200,000 Daltons to about 400,000 Daltons.

Aspect 33: the hollow fiber membrane according to any one of aspects 23 to 31, wherein the fluoro-copolymer has a weight average molecular weight of about 200,000 Daltons to 350,000 Daltons.

The following non-limiting examples serve to illustrate certain embodiments of the invention but are not to be construed as limiting. Variations and additional or alternative embodiments will be readily apparent to the skilled artisan on the basis of the disclosure provided herein.

### EXAMPLES

### Polymer Synthesis

### Example 1

2700 ml of a solution containing 30.49 g (0.114 mol) of Na₂HPO₄·7H₂O, 8.9 g (0.074 mol) of NaH₂PO₄, 4.45 g (0.0199 mol) of (NH₄)₂S₂O₈ and 30 g (0.069 mol) of C₇F₁₅CO₂NH₄ was added to a 2-gallon autoclave. The solution was cooled to about 5° C. 1492 g (13.09 mol) of trans-1,3,3,3-tetrafluoropropene (trans-HFO-1234ze) was added, followed by the addition of 639 g (9.84 mol) vinylidene difluoride (VF2).

7.5 g (0.0395 mol) of Na₂S₂O₅ dissolved in 50 ml H₂O was added at a rate of 5 ml/min. After the addition was complete, the reactor temperature was raised to 35° C. and maintained at that temperature for 7 days. The reactor was cooled 25° C., and the unreacted monomers were removed. The aqueous solution was drained from the reactor and diluted with an equal volume of H₂O. With constant stirring, 100 ml HC₁ (37%) was added over about 3 hrs to induce precipitation of the polymer. The resulting white solid was stirred for 2 hours, filtered, and washed with deionized (DI) water until the filtrate was neutral. After drying at 35° C. and ≦10 mm Hg, 1027 g (48% yield) of the copolymer was obtained. Analysis by NMR gave a composition of 70 wt % trans-1234ze /30 wt % VF2. The product had a weight average molecular weight of 1 million Daltons determined by GPC analysis as described above.

### Example 2

Using the procedure described in Example 1, a copolymer of 60/40 wt % trans-1234ze/VF2 was prepared in 53% yield by adjusting the monomer quantities to 1500 g (13.16 mol) of trans-1234ze and 1000 g (15.63 mol) VF2. The weight average molecular weight was 1 million Daltons.

### Example 3

Using the procedure described in Example 2, a copolymer of composition 60/40 wt % trans-1234ze/VF2 was prepared with a weight average molecular weight of 350,000 Daltons was prepared in 50% yield by raising the reaction temperature to 45° C.

### Example 4

As described in Example 2, a copolymer of composition 60/40 wt % 1234ze/VF2 having a weight average molecular weight of 200,000 Daltons was obtained by increasing the temperature to 55° C. with a yield of 41%.

### Example 5

Using the procedure described in Example 1, a copolymer of composition 70/30 wt % trans-1234ze/VF2 with a weight average molecular weight of 350,000 Daltons was prepared by changing the reaction temperature to 45° C. with a yield of 55%.

### Example 6

Using the procedure of Example 1, a copolymer of composition 70/30 wt % trans-1234ze/VF2 with a weight average molecular weight of 200,000 Daltons was prepared by changing the reaction temperature to 55° C. with a yield of 43%.

### Hollow Fiber Membrane Synthesis

### Example 7

A membrane casting solution was formed by dissolving 30 wt. % of the 60/40 wt % trans-1234ze/VF2 fluoropolymer polymer of Example 3 having a molecular weight of about 350,000 and 4.8 wt. % polyvinyl pyrrolidone polymer (PVP) having a K-value of about 85 - 88 in acetic acid (AcOH). The material was filtered and then pumped to a tube-in-orifice spinneret at a rate of 3.1 mL/min and a temperature of about 25° C. (R.T.). Simultaneously, a bore fluid comprising deionized (DI) water was, filtered, and delivered to the spinneret at a temperature of about 20° C. and a rate of about 3 mL/min. The membrane casting solution was delivered through the outer, annular orifice of the spinneret having an outside dimension of about 0.018 inches (about 460 microns) and an inside dimension of about 0.008 inches (about 200 microns). The bore fluid was delivered through a tube orifice within the annular orifice having an inside diameter of about 0.004 inches (about 100 microns).

The spinneret discharged the column of membrane casting solution and bore fluid downward into a coagulation water bath. The coagulation bath was maintained at about 35° C. and about 5.5 L/min of water was pumped into the tank with resulting water overflow. The fibers were then collected, and tested for inside diameter, and outside diameter.

Table 1 shows the spinning conditions for different solution casting speeds.

TABLE 1

| | | | | Soln. | | | | |
|---|---|---|---|---|---|---|---|---|
| | | | | casting | | | Coagulation | |
| Polymer | Solvent | Additive | | speed | Bore fluid | Speed | bath | Temp. |
| Type | Type | Type | Spinneret | (psi) | Type | (rpm) | Type | (° C.) |
| MW 350 | AcOH | PVP 2.5K | Enka | 7 | 100% | 400 | DI water | R.T. |
| (25 wt %) | (70 wt %) | (5 wt %) | | | H₂O | | | |
| MW 350 | AcOH | PVP 2.5K | Enka | 5.5 | 100% | 400 | DI water | R.T. |
| (25 wt %) | (70 wt %) | (5 wt %) | | | H₂O | | | |
| MW 350 | AcOH | PVP 2.5K | Enka | 9 | 100% | 300 | DI water | R.T. |
| (25 wt %) | (70 wt %) | (5 wt %) | | | H₂O | | | |
| MW 350 | AcOH | PVP 2.5K | Enka | 4.5 | 100% | 250 | DI water | R.T. |
| (25 wt %) | (70 wt %) | (5 wt %) | | | H₂O | | | |

The diameter of the hollow fibers was measured using a light microscope which has a calibration ruler in the field of view. The results are shown in Table 2.

TABLE 2

| OD | ID | wall |
|---|---|---|
| Mm | mm | mm |
| 0.766 | 0.537 | 0.115 |
| 0.832 | 0.704 | 0.064 |
| 0.803 | 0.453 | 0.175 |
| 0.771 | 0.604 | 0.084 |

### Example 8

Using the procedure described in Example 1, a copolymer of 60/40 wt % ze/VF2 was prepared in 32% yield by adjusting the monomer quantities to 1500 g (13.16 mol) of 1234ze and 1000 g (15.63 mol) of VF2. The reaction temperature was maintained at 35° C., and the reaction time was terminated after 4 days. This product had a weight average molecular weight of 502,000 Daltons.

### Example 9

Using the procedure described in Example 1, a copolymer of 60/40 wt % trans-'1234ze/VF2 was prepared with 48.5% yield by adjusting the monomer quantities to 1500 g (13.16 mol) of trans-1234ze and 1000 g (15.63 mol) of VF2. The reaction temperature was maintained at 35° C., and the reaction time was terminated after 4 days. This product had a weight average molecular weight of 1,000,000 Daltons.

A membrane casting solution was formed by dissolving 13 wt % of the polymer with the weight average molecular weight of 1,000,000 Daltons in acetic acid. The bore fluid and the coagulation bath were DI water. A 1.5 in air gap between the spinneret and the coagulation bath was used. The membrane casting solution was delivered to the spinneret at a casting speed of 25 psi and bore fluid speeds of 250 and 500 rpm, and a casting speed of 30 psi and bore fluid speeds of 300 and 500 rpm. However, hollow fibers could not be made because they broke almost immediately. The casting solution did not gel quickly enough.

### Example 10

The process of Example 7 was repeated to make hollow fiber membranes from the polymers in Examples 2, 4-6, and 8. These membranes are used in a separation process. A feed comprising two or more components is passed through the fluoro-copolymer hollow fiber membrane. We find that the hollow fiber membrane separates the feed selectively and provides a permeate comprising the first component and a retentate comprising the second component.

All temperatures are set forth in degrees Celsius and, all parts and percentages are by weight, unless otherwise indicated.

As used herein, the singular forms “a,” “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

It should be appreciated by those persons having ordinary skill in the art(s) to which the present invention relates that any of the features described herein in respect of any particular aspect of the present invention can be combined with one or more of any of the other features of any other embodiments and/or aspects of the present invention described herein. Such combinations are considered to be part of the present invention contemplated by this disclosure.

It is to be understood that both the foregoing general description and the detailed description are exemplary and explanatory only and are not restrictive of the invention as claimed. Other aspects will be apparent to those skilled in the art from consideration of the specification and practice of the invention disclosed herein.

What is claimed is:

1. A hollow fiber membrane comprising:
a hollow tube comprising a fluoro-copolymer having a weight average molecular weight between about 100,000 and 500,000 Daltons, the fluoro-copolymer comprising trans-1,3,3,3-tetrafluoropropene monomers and vinylidene difluoride monomers, wherein at least 50 wt % of the fluoro-copolymer comprises trans-1,3,3,3-tetrafluoropropene monomers.

2. The membrane according to claim 1, wherein the weight average molecular weight of the fluoro-copolymer is between about 200,000 and 400,000 Daltons.

3. The membrane according to claim 1, wherein the fluoro-copolymer comprises from at least 50 wt % to about 70 wt % of trans-1,3,3,3-tetrafluoropropene monomers.

4. The membrane according to claim 1, wherein the fluoro-copolymer comprises from about 55 to about 65 wt % of trans-1,3,3,3-tetrafluoropropene monomers.

5. The membrane according to claim 1, wherein the fluoro-copolymer comprises from about 58 to about 62 wt % of trans-1,3,3,3-tetrafluoropropene monomers.

6. The membrane according to claim 1, wherein the fluoro-copolymer comprises about 60 wt % trans-1,3,3,3-tetrafluoropropene monomers and about 40 wt % vinylidene difluoride monomers.

7. A process for producing a hollow fiber membrane comprising:
providing a membrane casting solution comprising:
a solvent selected from the group consisting of: ethyl acetate; acetone; cis- or trans-l-chloro-3,3,3-trifluoropropene; tetrahydrofuran; dimethylformamide; dimethylsulfoxide; dimethylacetamide; 1,1,1,3,3-pentafluorobutane; N-methyl pyrrolidone; ethanol; methanol; 1,3-dioxolane; or mixtures thereof; and,
a fluoro-copolymer having a weight average molecular weight between about 100,000 and 500,000 Daltons, the fluoro-copolymer comprising trans-1,3,3,3-tetrafluoropropene monomers and vinylidene difluoride monomers, wherein at least 50 wt % of the fluoro-copolymer comprises trans-1,3,3,3-tetrafluoropropene monomers;
spinning the membrane casting solution with a bore fluid through a spinneret to form a hollow fiber membrane; and
introducing the hollow fiber membrane into a coagulation bath.

8. The process according to claim 7, further comprising:
annealing the hollow fiber membrane after introducing hollow fiber membrane into the coagulation bath.

9. The process according to claim 8, wherein the hollow fiber membrane is annealed at a temperature of about 30° C. to about 100° C. for a time of about 10 minutes to about 3 hours.

10. The process according to claim 7, further comprising:
introducing the hollow fiber membrane into a solvent exchange bath after introducing hollow fiber membrane into the coagulation bath.

11. The process according to claim 10, wherein the solvent exchange bath comprises at least one of methanol and hexane.

12. The process according to claim 7, further comprising:
drying the hollow fiber membrane after introducing hollow fiber membrane into the coagulation bath.

13. The process according to claim 12, wherein the hollow fiber membrane is dried at a temperature of about 23° C. to about 150° C. for a time of about 1 minute to about 12 hours.

14. The process according to claim 7, wherein the coagulation bath comprises water.

15. The process according to claim 7, wherein the coagulation bath is at a temperature about 0° C. to about 30° C.

16. The process according to claim 7, further comprising:
coating the surface of the hollow fiber membrane with polysiloxane, a fluoro-polymer, a thermally curable silicone rubber, or a UV radiation curable silicone rubber after introducing hollow fiber membrane into the coagulation bath.

17. The process according to claim 7, wherein the membrane casting solution further comprises a pore forming compound.

18. The process according to claim 7, wherein the weight average molecular weight of the fluoro-copolymer is between about 200,000 and 400,000 Daltons.

19. The process according to claim 7, wherein the fluoro-copolymer comprises from about 50 to about 70 wt % of trans-1,3,3,3-tetrafluoropropene monomers.

20. The process according to claim 7, wherein the fluoro-copolymer comprises about 60 wt % trans-1,3,3,3-tetrafluoropropene monomers and about 40 wt % vinylidene difluoride monomers.

21. A separation process comprising:
providing a hollow fiber membrane according to claim;
passing a feed into the hollow fiber membrane, the feed comprising at least two components; and
selectively separating the feed into a permeate comprising the first component and a retentate comprising the second component.

22. The separation process of claim 21, wherein the separation process comprises at least one of reverse osmosis desalination, filtration, membrane distillation, pervaporation, and selective gas separation.
